(19) United States
(12) Patent Application Publication
(10) Pub. No.: US 2004/0042836 A1
(43) Pub. Date: Mar. 4, 2004

(54) Photo self-luminescent glowing phosphorous membrane resin pigment characters on computer key caps

(76) Inventors: Hakeem Al-Raheem, Turlock, CA (US); Michelle Huang, San Gabriel, CA (US)

Correspondence Address: HAKEEM AI-RAHEEM, 2246 Typhoon Court, Turlock, CA, 95380, US

(21) Appl. No.: 10/232,254

(22) Filed: Aug. 29, 2002

(51) Int. Cl. B41J 5/08

(52) U.S. Cl. 400/490

(57) ABSTRACT

The present invention relates to the uses of photo luminescent glowing membrane resin characters on computer key caps, providing human beings luminescent lighting while using standard conventional computer key cap(s) in low lighting or in darkness without requiring any internal electrical component(s), circuit(s) or power(s). This includes the using of photo luminescent glowing pigments/resin in the form(s) and shape(s) of every standard letter(s), symbol(s), word(s), and number(s) to be securely fixed and adhered in configuration on the superior surface(s) of a standard QWERTY computers keyboard key cap(s).

### DESCRIPTION OF THE FIGURE(S) OF THE DRAWING

Any broken line illustration of environmental structure in the drawing is not part of the design sought to be patented.

FIG. 1 is a front elevation superior view of a three-dimensional graphical art representing a conventional standard computer keyboard with key caps.

FIG. 2 is an enlarged front elevation superior view of a three-dimensional graphical art image representing of the said conventional standard computer key caps including images 1, 2 and 3.

FIG. 2 images 2 and 3 are mirror images of FIG. 1 representing a conventional standard computer keyboard with key caps.

FIG. 2—image 1 is an enlarged front elevation superior view of a said photo luminescent glowing phosphorous membrane resin pigment character represented in the shape of the letter

FIG. 2—image 2 is an enlarged front elevation superior view of a three-dimensional graphical art representing of the said conventional computer keyboard key cap superior surface.

FIG. 2—image 3 is an enlarged front elevation superior view of a three-dimensional graphical art representing of the said conventional computer keyboard key cap lower base.

FIG. 3 is an enlarged front elevation superior view of a three-dimensional graphical art mirror image representing of the said conventional standard computer key cap including in images 1, 2 and 3.

FIG. 3—image 1 is an enlarged front elevation superior view of a said photo luminescent glowing phosphorous membrane resin pigment character represented in the shape of the letter “E” securely fixed or adhered in configuration on the conventional computer keyboard key cap superior surface.

FIG. 3—image 2 is an enlarged front elevation superior view of a three-dimensional graphical art representing of the said conventional computer keyboard key cap superior surface.

FIG. 3—image 3 is an enlarged front elevation superior view of a three-dimensional graphical art representing of the said conventional computer keyboard key cap lower base.

FIG. 4 is an enlarged lateral view of a three-dimensional graphical art mirror image representing of the said conventional standard computer key cap including in images 1, 2 and 3.

FIG. 4—image 1 is an enlarged lateral view of a said photo luminescent glowing phosphorous membrane resin pigment character represented in the shape of the letter “E”securely fixed or adhered in configuration on the conventional computer keyboard key cap superior surface.

FIG. 4—image 2 is an enlarged lateral view of a three-dimensional graphical art representing of the said conventional computer keyboard key cap superior surface.

FIG. 4—image 3 is an enlarged lateral view of a three-dimensional graphical art representing of the said conventional computer keyboard key cap lower base.

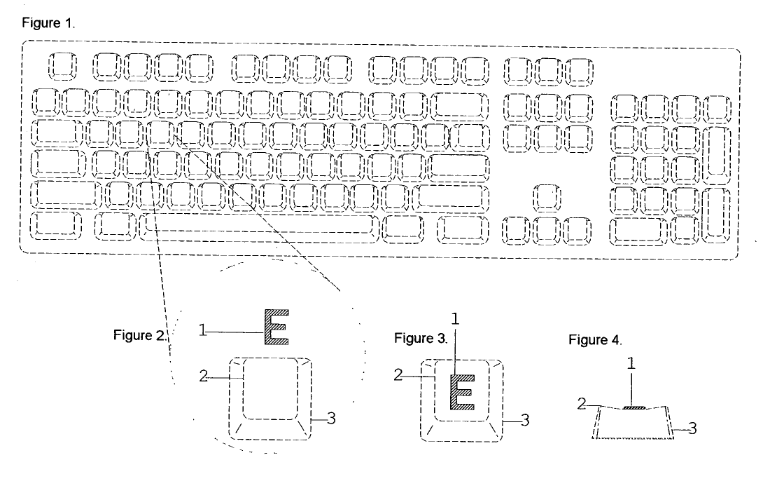

### FEATURE DESCRIPTION

### BACKGROUND OF THE INVENTION

The present invention relates to the uses of photo luminescent glowing phosphorous membrane resin pigment characters on computer key caps. Photo luminescent phosphorus is a self-luminescent membrane resin pigment material capable of absorbing photons of light, and emits self-luminescent glow lighting without requiring any internal electrical component(s), circuit(s) or power(s). The said key cap characters created with photo luminescent glowing phosphorous membrane resin pigment shaped in standard letter(s), symbol(s), word(s), and number(s) would enhance human beings sight while reading computer key cap character(s) in low lighting or in darkness.

This includes the using of photo luminescent glowing phosphorous membrane resin pigment in the form(s) and shape(s) of every standard letter(s), symbol(s), word(s), and number(s) to be securely fixed and adhered in configuration on standard QWERTY computer(s) keyboard key cap(s), will greatly enhance human beings abilities to operate computers while in areas of low lighting or in areas of darkness without requiring any internal electrical component(s), circuit(s) or power(s).

### SUMMARY OF THE INVENTION

More specifically, the present invention relates to keyboards having self-illuminated glowing phosphorous membrane resin pigment key characters.

The photo luminescent glowing phosphorous membrane resin pigment characters on computer key caps are able to provide self-luminescent lighting. The photo luminescent glowing phosphorous membrane resin pigment and can absorb and store the energy of various ultraviolet and visible light and release the energy in way of visible lighting in dark environment or in the dark without any internal electrical component(s), circuit(s) or power(s). The light absorption and release processes are automatically completed and repeated ceaselessly. The photo luminescent glowing phosphorous membrane resin pigment character is fixed or adhered in configuration to the superior surface(s) represents in the form(s) of standard letter(s), symbol(s), word(s), and number(s) used on standard QWERTY computer keyboard key cap(s).

The body of each photo luminescent glowing phosphorous membrane resin pigment characters on key caps is shaped in the form(s) to key cap(s) standard contour on the computer key cap(s) superior surface(s). The character(s) are fixed and adhered in configuration to the superior surface of the key cap.

The said photo luminescent glowing phosphorous membrane resin pigment character(s) increase the visibility of standard letter(s), symbol(s), word(s), and number(s) used on standard QWERTY computer keyboard key cap(s) without requiring any internal electrical component(s), circuit(s) or power(s).

### DESCRIPTION OF THE PREFERRED EMBODIMENT

The disclosure contains several different embodiments according to this invention. Where appropriate, like components or features will be referenced with the same numeral. To avoid redundant discussion, only different or distinct features of one embodiment as compared to another embodiment will be discussed in detail.

Photo luminescent glowing phosphorous membrane resin pigment character is shown in FIG. 2—image 1, FIG. 3—image 1 and FIG. 4—image 1.

The said photo luminescent glowing phosphorous membrane resin pigment character is represented in the shape of the letter “E” securely fixed or adhered in configuration on the conventional computer keyboard key cap superior surface, shown in FIG. 3—image 1 and FIG. 4—image 1.

I (we) claim the following:

1. The photo luminescent glowing phosphorous membrane resin pigments, are self-emitting character(s) in the form(s) and shape(s) of every standard conventional QWERTY computer key cap's letter(s), symbol(s), word(s), and number(s) and securely fixed or adhered, in configuration on the superior surface of a plurality conventional standard QWERTY computer keyboard's key cap(s) superior surface(s) therein.
